(19) United States
(12) Patent Application Publication
(10) Pub. No.: US 2005/0138426 A1
(43) Pub. Date: Jun. 23, 2005

(54) Method, system, and apparatus for managing, monitoring, auditing, cataloging, scoring, and improving vulnerability assessment tests, as well as automating retesting efforts and elements of tests

(76) Inventor: Brian Styslinger, Saratoga, CA (US)

Correspondence Address: MATTINGLY, STANGER & MALUR, P.C.;ATTORNEY AT LAW, SUITE 370, 1800 DIAGONAL ROAD, ALEXANDRIA, VA, 22314, US

(21) Appl. No.: 10/982,930

(22) Filed: Nov. 8, 2004

Related U.S. Application Data
(60) Provisional application No. 60/517,869, filed on Nov. 7, 2003.

(51) Int. Cl. G06F 11/30; G06F 15/16

(52) U.S. Cl. 713/201; 380/1; 709/224

(57) ABSTRACT

A scalable method, system, and apparatus for non-intrusively auditing and improving security assessments includes capturing, storing, presenting, displaying, inspecting, monitoring, and analyzing data flow in client-server security assessments and/or network/infrastructure security assessments. The invention provides interested parties with a mechanism to non-intrusively audit in real-time the vulnerability test effort, as well as review, replay, and analyze all aspects of the security assessment during and after the test. For web application assessments, the data capture includes one of the following or some combination: an intermediary with all data passing through the intermediary; a sniffer that can passively extract all data being communicated between the application and tester; and a plurality of computing modules (e.g., software, appliances, etc.) installed in the tester environment or within the application system environment (e.g., software installed on the tester's computer, or on the computer where the intermediary is running, or software installed on the application systems proxy or web server, or an appliance in either environment) for storing, processing, analyzing, reporting, and displaying the data.

### CROSS-REFERENCES TO RELATED APPLICATIONS

This application claims the benefit of U.S. Provisional Application Ser. No. 60/517,869, filed Nov. 7, 2003.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The invention relates generally to the monitoring and auditing of computer security testing. More particularly, the invention is directed a mechanism for auditing, monitoring, scoring, reducing costs, automating retesting and elements of the testing effort, and improving vulnerability/penetration tests.

2. Description of the Related Art

To improve security in computer systems, it is a common practice for those in charge of security of applications and networks to have a vulnerability/penetration assessment or “ethical hack” performed to test the security. These security assessments are designed to identify and enumerate weaknesses in the security that is in place, by implementing attacks and the providing solutions for improving security. However, security assessments are costly and are not wholly audited or scored for performance, with the result that there is no way to determine the effectiveness of the security assessment, and thereby, no true way to gauge the actual effectiveness of the security.

Thus, there is a need for a system and method for monitoring and grading security assessments. The solution should be a scalable and easily integrated into the assessment process and testing architecture. In addition, the solution should be effective at auditing, managing, scoring/ranking/benchmarking application and network security and vendor performance, while also improving, logging, leveraging, and automating portions of the overall process. To illustrate the current state of the art, set forth below is a detailed background discussion related to the practice of web application security assessments, a particular type of client-server application.

Familiarity with the following terms will aid the reader in understanding the background discussion and the detailed description of the invention.

Applet: A Java® program embedded in a web page and executed in a Java®-enabled web browser.

Web Browser: A client application connected to the World Wide Web that requests resources from a web server, usually for the purpose of displaying the requested resources. Examples of browsers are Internet Explorer and Netscape Navigator.

Proxy: A proxy is an intermediary program which acts as both a server and a client for the purpose of making requests on behalf of other clients. Requests are serviced internally or by passing them on, with possible translation, to other servers. A proxy must implement both the client and server requirements of a specification. A “transparent proxy” is a proxy that does not modify the request or response beyond what is required for proxy authentication and identification. A “non-transparent proxy” is a proxy that modifies the request or response in order to provide some added service to the user agent, such as group annotation services, media type transformation, protocol reduction, or anonymity filtering. Except where either transparent or non-transparent behavior is explicitly stated, the HTTP proxy requirements apply to both types of proxies.

Cookie: A packet of information sent by an HTTP server to a web browser and then sent back by the browser each time the browser accesses that server. Cookies can contain any arbitrary information the server chooses and are used to maintain state between HTTP transactions. Cookies are not visible to the browser user.

Directory: A simulated file folder on disk.

GUI (Graphical User Interface): A graphics-based interface that incorporates icons and/or pull-down menus and user interaction with the GUI.

CGI (Common Gateway Interface): A standard for running external programs from a HTTP server.

CGI Script: A small program written in a script language such as Perl that can be invoked through a request to the web server.

ASP® (Active Server Pages): A scripting environment developed by Microsoft Corporation. ASP® allows HTML, scripts, and ActiveX components to be combined to create dynamic web pages.

HTML (Hypertext Markup Language): A hypertext document format used on the World Wide Web.

DHTML (Dynamic HTML): An extension of HTML, created by Microsoft Corporation. DHTML gives greater control over the layout of page elements and the ability to have web pages which change and interact with the user without having to communicate with the server.

XML (Extensible Markup Language): An initiative defining an “extremely simple” dialect of SGML suitable for use on the World-Wide Web.

SGML (Standard Generalized Markup Language): A generic markup language for representing documents. SGML is an International Standard that describes the relationship between a document's content and its structure. SGML allows document-based information to be shared and re-used across applications and computer platforms in an open, vendor-neutral format.

JavaScript®: Designed by Sun Microsystems and Netscape Communications Corporation as an easy-to-use scripting language of Java® programming. JavaScript® code can be inserted into standard HTML pages to create interactive documents.

HTTP (HyperText Transfer Protocol): The client-server TCP/IP protocol used on the World Wide Web for the exchange of documents.

HTTPS (HyperText Transfer Protocol, Secure): A protocol for handling secure transactions that involves the use of SSL underneath HTTP.

HTTP Server: A server process running at a web site that sends out web pages in response to HTTP requests from remote browsers.

HTTP Client Agent: A client is a program that establishes connections for the purpose of sending requests. A user agent is a client which initiates a request. These are often browsers, editors, spiders (web-traversing robots), or other end user tools.

HTTP Session: Allows the server to maintain state between different HTTP requests. The HTTP server knows which session to associate with the request because the browser sends the session ID as part of the request. This can either be done with a cookie or by adding a parameter to the request URL.

LRI (Local Resource Identifier): The location of the resource relative to the hierarchical structure of the server.

URL (Uniform Resource Locator): A compact string representative of resources available via the network. A URL has the form <protocol>://<server name><LRI><? optional parameters>.

Process: A self-contained operating environment that behaves as if it is a separate computer. A Java® virtual machine is a Java® interpreter that converts Java® byte code into machine language one command at a time and then executes it.

SSL (Secure Sockets Layer): A protocol designed by Netscape Communications Corporation to provide encrypted communications on the Internet. SSL is layered beneath application protocols such as HTTP, SMTP, Telnet, FTP, Gopher, and NNTP, and is layered above the connection protocol TCP/IP.

One source of vulnerability for computer systems connected to the Internet is web applications. A web application is a client-server application. The client makes HTTP requests to the server, and the server provides responses based on the input provided by the client and the application logic and data within the application. Web developers often wrongly assume that the user input is constrained and cannot be manipulated, thus obviating good programming practices that requires vetting all user input. This assumption is founded upon an incorrect understanding of the security that the SSL (secure sockets layer) protocol attempts to provide, as well as upon the mistaken notion that user input manipulation attacks require breaking SSL (which is not believed to be feasible or practical if correctly implemented using 128-bit keys).

Proxies are standard well-known Internet technology components that allow companies to funnel traffic through a single point. This provides a number of useful characteristics and capabilities (e.g., caching for increased download speed, anonymity, access control, filtering, IP address space, etc.) Various types of proxies exist. For gateway proxies, the proxy is an SSL end-point; essentially a separate SSL session is set up between each client/server pair (e.g., browser/company proxy, company proxy/reverse proxy, etc), so at each proxy the communication is fully decrypted then re-encrypted with a new key known by the communicating pair. Proxies are intermediary programs which act as both a server and a client for the purpose of making requests on behalf of other clients. Requests are serviced internally or by passing them on, with possible translation, to other servers. A proxy must implement both the client and server requirements of this specification.”

In the past, “hackers” have re-engineered proxies to create a proxy tool such that the data passing thru the proxy and being decrypted and then re-encrypted is trapped before being forwarded. This allows the hacker to manipulate the data before being transmitted to the server. The proxy tool allows the attacker to exploit the above assumptions and manipulate the data being supplied to the server. If the code does not properly vet the ‘munged’ user input, it may be possible to exploit coding flaws. Attacks may result in the attacker obtaining unauthorized access to data; masquerading as another user; executing fraudulent or unauthorized transactions, such as embezzling money, etc.

While conducting vulnerability/penetration assessments is often an effective method of identifying security flaws, an existing problem in contracting this type of effort is that neither the client nor the people managing the effort understand the under-the-cover details of the effort. Therefore, it is a simple exercise for the person or company performing the ‘ethical hack’ to either purposely fudge the effort and cost or simply provide substandard and inconsistent assessments. The result can be an overpriced (comparatively high profit margin) service of possibly poor quality.

To reduce costs and improve performance, several companies have attempted to automate some security assessment components. In their own right, these automated security assessments test specific weaknesses in the system, but due to the changing and the dynamic nature of the Internet, complexities in the associated applications and Internet landscape (and related public and private networks) these security assessments are currently not comprehensive, not on par with manual “ethical hacks”, and are not likely to ever overcome complexity and various other dynamics necessary to completely automate the effort. Furthermore, these automated hacks may provide a false sense of security due to their inability to take into account slight variations on hacking methods.

Accordingly, the security assessment process cannot currently be completely automated, and it is likely that it never will be able to be completely automated. However, regardless of the asserted capabilities of automated security assessments, both automated and manual security assessments should be monitored, and at times audited and scored for performance. To improve service and security as well as reduce costs, the present invention provides a mechanism to access all data being communicated between the tester and the web application system, as well as actions being taken by the tester, thereby allowing an auditor or other interested user to non-intrusively monitor/shadow and record the manual and automated hacking efforts during a security assessment.

### BRIEF SUMMARY OF THE INVENTION

In a first aspect, the invention provides a system, method, and apparatus for managing, monitoring, auditing, inspecting, analyzing, cataloging, scoring, and automating vulnerability testing efforts and elements of testing, as well as reducing cost, improving quality and consistency, increasing assurance and confidence in the assessment effort, while improving the effectiveness of vulnerability/penetration assessments in general. The invention includes an elegant, unobtrusive, and scalable method, system, and apparatus that is easily integrated into the assessment and penetration testing process for accessing data communicated between the testing entity and the application system, and which allows for the deciphering and decoding of data that is ciphered and/or encoded. The invention then leverages this data by integrating and applying various technologies (e.g., parsers, storage, database, encryption tunnels, secure remote access, access control, various logic, interpreters, displays, proxies, automated scanning, and signals and alerts) to fulfill the objectives outlined above as well as others, including the following examples:
Determine, record, and signal whether security assessment work is being performed, or whether an automated tool is being used
Audit the security assessment effort;
Monitor the security assessment effort;
Assess the security assessment effort;
Assess the scope of the security assessment;
Assess whether there is over-charging for the security assessment;
Provide auditors and other interested authorized and authenticated users with the ability to monitor security assessments in real-time;
Provide auditors and other interested authorized and authenticated users with the ability to review security assessments after the assessment is completed;
Provide auditors and other interested authorized and authenticated users with the ability to easily make ad-hoc queries about either an assessment currently in progress or a past security assessments;
Provide signals and alerts regarding the testing effort (e.g., inactivity, automated scanner use);
Provide auditors and other interested users with information indicating the completeness and efficacy of the security assessment;
Provide auditors and other interested and authorized users with built-in reports and the ability to generate ad-hoc reports regarding security assessments;
Provide the means to capture security assessment techniques and methodologies and identify vulnerable materials;
Catalog pages/scripts tested by security assessments;
Create a log of the security assessment testing efforts;
Automate retesting efforts as well as elements of the testing effort;
Benchmark vendor testing efforts for a particular application;
Benchmark risks across applications; and
Generate reports associated with different aspects of the assessment.

To improve service and security as well as reduce costs for security assessments, the present invention provides a mechanism to non-intrusively monitor or shadow manual and automated security assessments, including: capturing testing activities and data, providing real-time display of testing activities and data, storing testing activities and data, generating and displaying metrics associated with testing data, and ranking application security and vendor capabilities.

Thus, in one aspect, the invention is directed to a method, system and apparatus for managing, monitoring, auditing, improving and scoring client-server application vulnerability/penetration assessments, as well as automating retesting efforts and supplementing and replacing elements of the initial security assessment. The invention includes data access and collection functionality, whereby an elegant, non-obtrusive method, system, and apparatus are easily integrated into the assessment process. The invention is scalable and provides access to all data communicated between the Testing Entity and the Application System. The invention further includes deciphering/enciphering, decrypting/encrypting, decoding/encoding functionality, where necessary, for performing these respective functions on the data flowing between the testing entity and the application system.

Under additional aspects, the invention includes capture, and store data functionality that captures, stores, and logs all encrypted and unencrypted data flowing between the testing entity and the application system. Thus, the invention stores and catalogs both deciphered raw unaltered and altered data (e.g., HTTP request and response messages), and parsed data. Also, the invention is able to store and/or log all data flowing between the testing entity and the application system, including connection and handshaking (e.g., web application requests and responses for content not requiring authorization and for content requiring authorization).

Under another aspect, the invention includes functionality that parses data, stores parsed data, analyzes data, and builds databases, including parsing all requests and responses, and intelligently storing the requests, responses, and parsed data (e.g., for web applications, URLs, paths, script names, HTTP Request and Response Headers, POST and GET parameters and values, Identification and Authentication credentials, session token names and values). The invention can then create a database of the vulnerability testing effort (e.g., for web applications, the database may include: all Pages/Scripts Requested, for all accounts and authorized/unauthorized requests; all URLs; all requested Pages/Scripts and actual Requests and Responses for each test account; all Pages/Scripts requested not associated with an account; aggregate of all submitted parameters for each Request/Script/Page and all values for each; all parameters submitted for a particular Request/Script/Page for each account and the associated values for each parameter; scripts requested, parameters included with each request and all values for each parameter; results for each Request). The invention can allow for the generation of a superset vulnerability database of vulnerable material that consolidates all the vulnerable material requested from all of the tests conducted using an implementation of this method and which can be leveraged to enhance the testing effort.

Under yet an additional aspect, the invention includes displays and interpreters that allow real-time and offline monitoring and viewing of all aspects of the security assessment. This aspect includes providing interested and authorized users the ability to monitor the testing effort in real-time by displaying the data flowing between the testing entity and application, as well as actions being taken by the testing entity (e.g., in the case of web applications, providing a view of both the deciphered raw HTTP Requests and Responses as well as a separate view of the rendered and/or interpreted Requests and Responses, and parameter manipulation). Thus, the invention provides auditors and other interested, authorized and authenticated parties with a real-time view of what the tester is doing and seeing. This invention also displays various real-time signals and alerts that provide authorized and interested users with information about the present state of the vulnerability testing effort (e.g., whether work is being performed, whether an automated tool is being used, area of the application system being evaluated, and the like). The invention further is capable of displaying other performance parameters, requested pages, and the like.

Under an additional aspect, the invention includes an analyzer functionality that applies logic and rules to the data being communicated between the testing entity and the application system, to thereby yield information about the data itself, the application system, and the testing effort, including the state-of-the-art, the vendor capabilities, trends, and statistics. The invention can then apply this to a data/information reporting functionality that will allow authorized and interested parties to easily make ad-hoc and pre-canned queries against the stored data for either the test currently in progress or a past test. Thus, the invention can provide interested parties with reports containing various information indicating the completeness and efficacy of the test(s), including: statistics, comparison data, directories, scripts tested, accounts and passwords used, all parameters used, and all submitted values for each page/script. This provides authorized interested parties with the ability to compare tests, applications, and vendors capabilities, and further allows authorized interested users with built-in reports regarding the testing effort and benchmark risk posture. In addition, authorized users are provided with statistical reports that may list the attacks against each page/script and associated parameters for each by User ID and in aggregate.

Under another aspect, the invention includes feedback loop and process improvement functionality that allows for the capturing and storage of assessment techniques and methodologies. This aspect allows for the capturing and building of a database of vulnerable material. This can also enable an automation and testing engine that can be leveraged by authorized testers to streamline and improve the test effort. This allows authorized users with the ability to re-run previous tests, such as replaying tester requests and or re-running scans.

These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated, wherein:

FIG. 1 illustrates a block diagram of the various functional elements of the invention according to three embodiments of the invention.

FIG. 2 illustrates a logical diagram of the various functional elements, depicting the general relationship between the components comprising the invention according to a first embodiment of the invention.

FIGS. 3a-3b illustrate a high-level flowchart of the method in operation of a first embodiment of the invention.

FIG. 4 illustrates a flow chart blow-up of the preparation steps, implementation decisions, and configuration of the method of a first embodiment of the invention.

FIGS. 5a-5c illustrate a detailed flowchart of a method of a first embodiment of the invention.

FIG. 6 illustrates an example GUI that allows the auditor to select one of the efforts that is being captured.

FIG. 7 illustrates an example GUI for the graphical display in accordance with one embodiment of the invention.

FIG. 8 illustrates the GUI displaying a list of HTTP requests, and the raw request for a particular request selected from the list, as well as selectable buttons for the raw response and filters.

FIG. 9 illustrates the GUI displaying a list of HTTP requests, and the raw request for a particular request selected from the list, as well as selectable buttons for the raw response and filters.

FIG. 10 illustrates a logical diagram of the various functional elements, depicting the general relationship between the components comprising the invention according to a second embodiment of the invention.

FIG. 11 illustrates a flow chart blow-up of the preparation steps, implementation decisions, and configuration of the method of a second embodiment of the invention.

FIG. 12 illustrates a logical diagram of the various functional elements, depicting the general relationship between the components comprising the invention according to a third embodiment of the invention.

FIG. 13 illustrates a flow chart blow-up of the preparation steps, implementation decisions, and configuration of the method of a third embodiment of the invention.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views.

The invention provides a mechanism for non-intrusively auditing vulnerability/penetration test assessments and similar computer security tests by capturing, presenting, displaying, inspecting, monitoring, and analyzing data flow in a client-server application (such as a web application) as well as in network penetration/vulnerability tests. The method, system, and apparatus of the invention provides users, (managers, hired auditors, application owners, CISO's (chief information security officers), etc.) with a mechanism to non-intrusively oversee in real-time the security test effort, determine whether work is being performed for billed hours, capture the results of the effort for off-line review and comparison across vendor efforts and applications, improve quality, measure and evaluate the level of effort and completeness, and capture methodology that can be pushed out to other vendors. Where possible, the method, system, and apparatus of the invention are also be scalable, allowing multiple efforts to be monitored, audited, and analyzed concurrently. Additional embodiments of the invention provide capabilities to improve the efficacy and efficiency of the vulnerability test effort by providing various data, information, and tools for the tester. For clarity, the following detailed description is outlined into two principal sections: auditing of client-server application vulnerability/penetration testing, and auditing of infrastructure vulnerability/penetration testing.

Under the invention, the tester can be any element that actuates the application, generating requests and responses, such as an automated vulnerability scanner (e.g., whisker, nessus, nikto, appscan, kavado), consultants generating requests and associated responses, or some other tools used by a consultant to activate the application. Automated scanners include any machinery, software, or tool that actuates the application (usually generating requests to the application) and may be designed to determine and enumerate vulnerabilities for the application.

A consultant is any one or a collection of people activating the application, or generating any type of requests against the application. The requests can be generated manually or through the use of some tool. Other tools that might be testing entities can include any mechanism used to actuate the application for generating requests in order to identify and enumerate potential vulnerabilities existing within the application system.

As applied to client-server application testing of the invention, auditing capabilities are fulfilled by providing the means to: capture all client-server transaction data; decipher where necessary captured data; and allow multiple users or auditors (e.g., managers, hired auditors, application owners, chief information security officers (CISO's), etc.) remote access for viewing the exchange of transaction data as well as resultant rendered pages. These auditing capabilities include: capturing, deciphering, presenting, displaying, inspecting, monitoring, and analyzing data flow in the client-server application test to non-intrusively watch-over in real-time the vulnerability test effort; determining whether work is being performed for billed hours; capturing the results of the effort for off-line review and comparison between vendor efforts; improving quality; measuring and evaluating the level of effort and completeness; and capturing methodology that can be pushed out to other vendors.

An unlimited number of different client-server applications fall within the scope of the invention. In the detailed description that follows, an exemplary embodiment of an HTTPS web client-server application is used for illustrating the principles of the invention. However, it should be understood by one of ordinary skill in the art that the principles of the invention are applicable to other client-server applications and other embodiments of the illustrated HTTPS web client-server application. For convenience, the following detailed description for the client-server web application principal section is outlined into the following sub-sections: (1) Functional Features; and (2) Architecture.

For each HTTP transaction, the invention allows the auditor to view, in real-time or at a later time, the raw request and response data as well as the rendered page. Additionally, each request and response will be stored. Further, the request and response is parsed, extracted, grouped, aggregated and stored according to various logic functions. The invention also provides a facility for saving request and response transactions so that the transactions can be explored at a later time. Further, the data parsed from the collection of requests and responses as well as generated information is stored in such a way as to allow the auditor to group data in various ways or make ad-hoc queries. For example, an auditor might query the database for all the values submitted for a particular parameter submitted to a particular server script (e.g., ASP, servlet, JSP, etc.), thus providing the auditor with one ad-hoc data point for scoring the testing effort.

In general, the invention includes some or all of the following: (A) a mechanism to extract, decipher, view, and capture actions and activities being conducted by the tester and data communicated between the application and the tester; (B) a data collector that collects and stores transaction data (e.g., the entire request and response is captured, including the URL, HTTP headers, and all variable parameters and values); (C) a database and directory for storing data and accessing organized stored data; (D) an analyzer that inspects the data being captured and generates information based on logic, other inputs, and the captured data; (E) a logic component, where necessary, that interprets transaction data and enables the data to be rendered; (F) a graphical display and/or interfaces that provides a mechanism for viewing in real-time ‘raw’ transaction data, rendered or interpreted data, and data generated from the analyzer as well as display data, rendered data, and other information stored in the database (e.g., for selected captured transactions, the raw HTTP request and raw HTTP response page served to the tester based on the tester's request will be displayed, as well displaying the rendered page, thusly providing the interested party a view into the effort); and (G) attack profiles for commercial and publicly-available scanners allowing the method, system, and apparatus of the invention to identify automated scanner use.

The invention comprises several embodiments for each of the components. In particular, the data capture can include one or more of the following mechanisms: (1) an intermediary (proxy) with all data passing through the intermediary—in this embodiment, the intermediary implements all functions of both an HTTPS client agent and HTTP server agent, and for SSL communication, the intermediary serves as an SSL end-point; (2) a sniffer that can passively extract all data being communicated between the application and tester—in this embodiment, the sniffer is provided with the origin server (or reverse proxy), client certificate(s), and associated keys; and (3) computing modules placed within the testing entity or application system environment (e.g., software components placed on the testing entity computer or application system—web or proxy server—or appliances integrated into the testing entity or application system).

Functional Features

The invention provides functional features or capabilities including: real-time view into the HTTP request/response transactions and page rendering (essentially quantifying work or showing that work is being performed); capture and collection of the transaction data (essentially gathering the data necessary to qualify the work being performed); storage for retaining collected data, generated information, and metrics; interpreters for rendering data; logic for analyzing the data and effort, logic for measuring the effort, logic for scoring the effort, logic for generating metrics, logic and profiles to determine whether automated tools are generating the request stream; secure storage of collected data and generated information; access control; secure remote access; and the ability to concurrently audit multiple application tests concurrently.

One functional feature is data access and capture. Embodiments include: (1) extracting data from a point between the tester and server by either passively extracting the data ‘off the wire’, or acting as an intermediary relaying requests and responses; (2) providing computing modules within the testing entity or application system environment: either appliances with access to the communicated data (e.g., connected to a hub), or software that can be installed on the tester's platform (e.g., a computer where browser or proxy is running), or the application system (e.g., a reverse proxy, web server, application server, etc.) or a combination of the above. Where the data collector is physically separated from other functional elements of the invention, these mechanisms may either store the data locally and/or securely transmit the accessed data back to a central processing and storage engine and/or allow. Further, these components allow authorized, authenticated auditors to log into the computer and view the actions of the tester and the results of those actions in real-time (essentially the auditor is viewing the tester's display (3) a combination of the foregoing.

Another functional feature of the invention is the security provision, including: the ability to control, protect, and govern access to the various components (e.g., users, source and destinations, connect, authenticate, scan, target application system, and view); ensure the confidentiality and integrity of data collected and information created; and protect the data and information. The invention includes authentication, encryption, authorization, and other security functional elements to provide the necessary security.

Another functional feature of the invention is the provision to allow the auditor to view in real time the HTTPS transactions in raw data form as well as the resultant rendered page. An embodiment of the invention provide this capability by allowing the auditor to remotely connect to the testers platform and view the actions of the tester as well as the HTTPS transactions and rendered results (e.g., connecting to the tester's platform, essentially exporting the tester's GUI). Alternatively, data may be securely streamed to a central processing and storage engine and/or the auditor's computer where the necessary logic elements present the raw data as well as rendered resultant pages and some of the actions of the tester (i.e. with access to the data and other logic and mechanisms, the actions of the tester can be deduced). Another embodiment allows real-time viewing of the HTTPS transaction data by allowing the auditor to remotely connect to a system where captured data is displayed and rendered.

Embodiments include the following mechanisms for acquiring the captured data either at the tester's computer or application system, or at a point somewhere between the tester and the server. For data acquired at the tester's computer or application system, this data is securely streamed to the system and apparatus of the invention. For data captured at a point somewhere between the tester and the tested system, the data may be acquired by passively sniffing the data off the wire or communication channel. Alternatively, an intermediary may be used that performs all of the functions of both an HTTPS client agent and HTTPS server agent; for SSL, the intermediary would be an SSL end-point for both the tester-to-intermediary proxy and for the intermediary proxy-to-server.

Another functional feature is the ability to identify the use of automated scanning tools. Embodiments of the invention contain automated scanning signatures that provide this capability.

Architecture

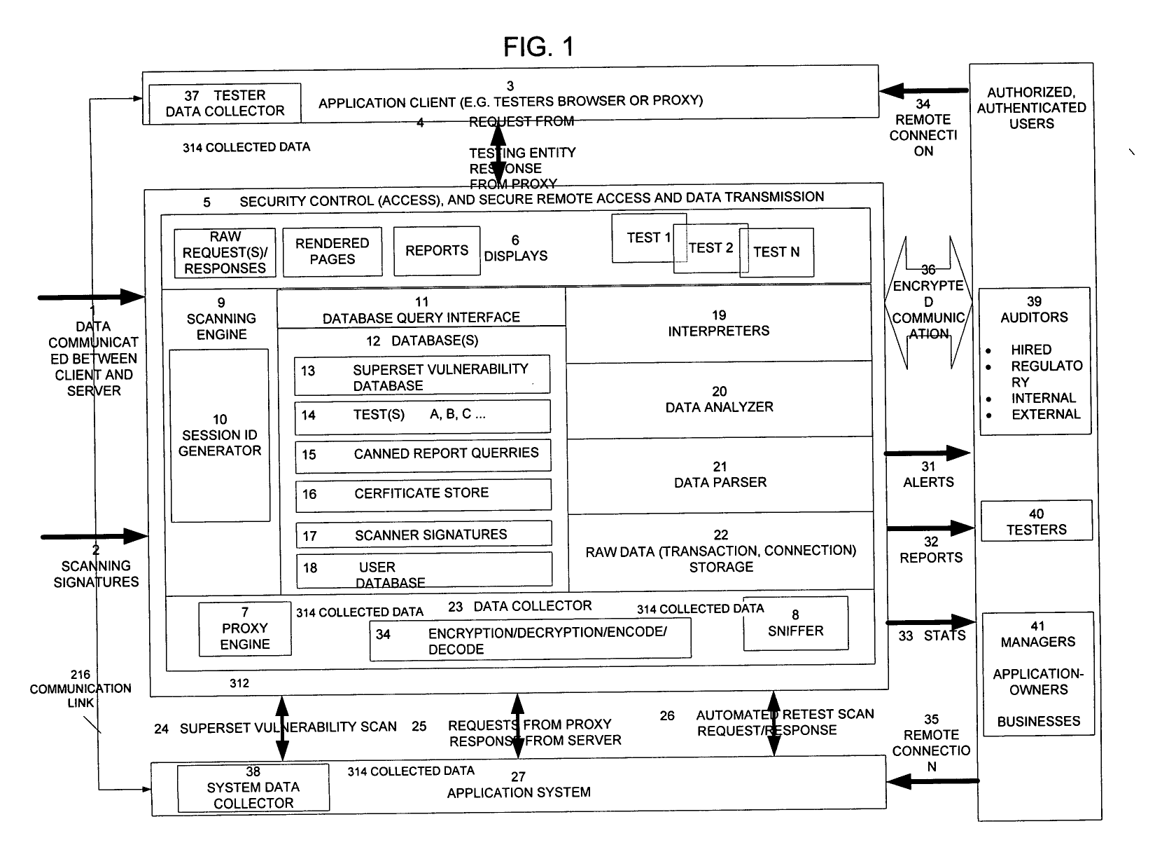

FIG. 1 shows a block diagram of functional elements according to one embodiment of the invention. The invention includes a system, network, application, application system, or other structure (application system 27) to be tested by a security assessment. An application client 3 (e.g., browser) for use by the tester is able to communicate with application system 27 via a communications link or channel 216. Application client 3 includes any of the following: a web browser (e.g., Internet Explorer), a tester's proxy (e.g., FormScalpel), a computer hosting a web application scanning tool (e.g., AppScan) that makes HTTPS requests, or an appliance that performs automated web application scanning as is known in the art.

One category of functional elements depicted within FIG. 1, include data collectors, which acquire HTTPS transaction data 1 communicated between application client 3 and application system 27. An embodiment of the invention uses one or a combination of data collectors. The data collectors of the invention can be logically grouped by the physical location where the data is acquired: at the application client 3 or application system 27, or at some point between the application client 3 and the application system 27.

The tester data collector 37 for this embodiment is comprised of software or a system collocated with the application client 3. Tester data collector 37 is installed on the tester's testing platform prior to the execution of the security test, and captures all HTTPS transaction data. Alternatively, or additionally, a system data collector 38 may be installed at the application system 38. The captured data 314 may be stored and processed locally and/or sent data through a secure channel 310 to a central mechanism 312 comprising functional components handling processing, storage, and display (5, 6, 9-22) or to auditor 39.

The functional components of central mechanism 312 include security control 5 for controlling remote access and data transmission. Displays 6 may be provided for displaying raw requests and responses, rendered pages, reports, and the like. Other functional components may include a scanning engine 9, a session ID generator 10, a database query interface 11 for interfaces with databases 12. Databases 12 include a superset vulnerability database 13, a test database 14, a canned report query database 15, a certificate store 16, scanner signature database 17, and user database 18. Other functional components can include interpreters 19, a data analyzer 20, a data parser 21, and a raw data storage 22 for receiving and storing collected data 314.

The proxy data collector 23 for use in some embodiments of the invention is comprised of software or a system that is located between the application client 3 and the application system 27. The proxy data collector 23 either passively extracts the data from communications channel 216 using a sniffer 8, or actively captures the data using an intermediary proxy engine 7. Sniffer 8 is loaded with necessary certificates and keys, allowing for the deciphering of SSL traffic on communications link 216. Correspondingly, the intermediary proxy 7 is loaded with certificates for communications with both the application client 3 (browser or other proxy) and the application system 27 (web server, reverse proxy, etc.). Intermediary proxy 7, in addition to capturing and where necessary deciphering data, provides all of the functions of an HTTPS client and HTTPS server, relaying requests and responses between the application client 3 and the application system 27. The proxy data collector 23 also provides the collected data 314 to the processing elements of the invention (5, 6, 9-22) or to the auditor 39, or both. The proxy data collector 23 may also have additional connections to other functional elements.

A tester 40 may interface with the intermediary proxy 7 in the following ways: using the intermediary proxy 7 as the test proxy; turning on proxying within the application client (browser, proxy, scanner) and setting the appropriate IP address and port of the intermdiary proxy 7; or seeing the intermediary proxy 7 as the origin server, hard coding the real origin server IP address and port into the intermediary proxy 7.

Within the processing elements, an analyzer 20 examines the captured data 314, and based on various internal logic as well as input from scanning signatures 2, generates additional information that is also stored in a database as well as presented to a graphical display 6. Embodiments of analyzer 20 include logic to correlate data providing additional insight into the testing effort. For example, analyzer 20 identifies particular sessions and the associated requests and responses with a user ID used to establish the session. The analyzer 20 does this for each user ID used for establishing a session. The Analyzer 20 then examines the sets of requests for each user ID and determines which requests were made and not made for each user ID. This can be used to determine whether forced browsing was comprehensively tested.

The graphical display 6 provides the auditor 39 with a visual interface to display all elements of the testing effort(s) in real time as well as allow the auditor 39 to inspect the data and information at a later time. Other authorized, authenticated uses that might be given access to the displayed data include managers, application owners, businesses 41, and the testers 40. Data and information that the graphical display 6 displays includes, tests 1, 2, . . . n, being audited, raw HTTPS transaction data (requests, responses, parameters, variables and values), rendered result pages/page-sets, reports 32, alerts 31 (e.g., use of an automated scanner), alarms (e.g., no testing activity), ad-hoc queries of data stored in the database 12, configuration options for alerts and alarms, and other information and stats 33. The graphical display 6 has connections to various components including all databases, the analyzer 20, data collectors 23, and interpreters 19. The interpreter 19 provides the processing and logic necessary to create rendered pages.

The database 12 contains automated scanner signatures 17 allowing the invention to determine when automated tools are being used and signal the auditor 39. The scanner signatures 17 are either compiled using the invention, or provided by the owner of the scanner.

Embodiments of the invention provide remote access 5 capabilities, allowing one or more authorized users to connect to various components, systems, and/or functional elements. This may be via encrypted communications 36 between the authorized users and central mechanism 312, and the authorized users may also have remote connection 34 to the application client 3 and/or remote connection 35 to the application system 27. Communications between the application system and central mechanism 312 include superset vulnerability scans 24 passed on by the central mechanism 312, normal requests from proxy and responses from server 25, and automated retest scan requests and responses 26.

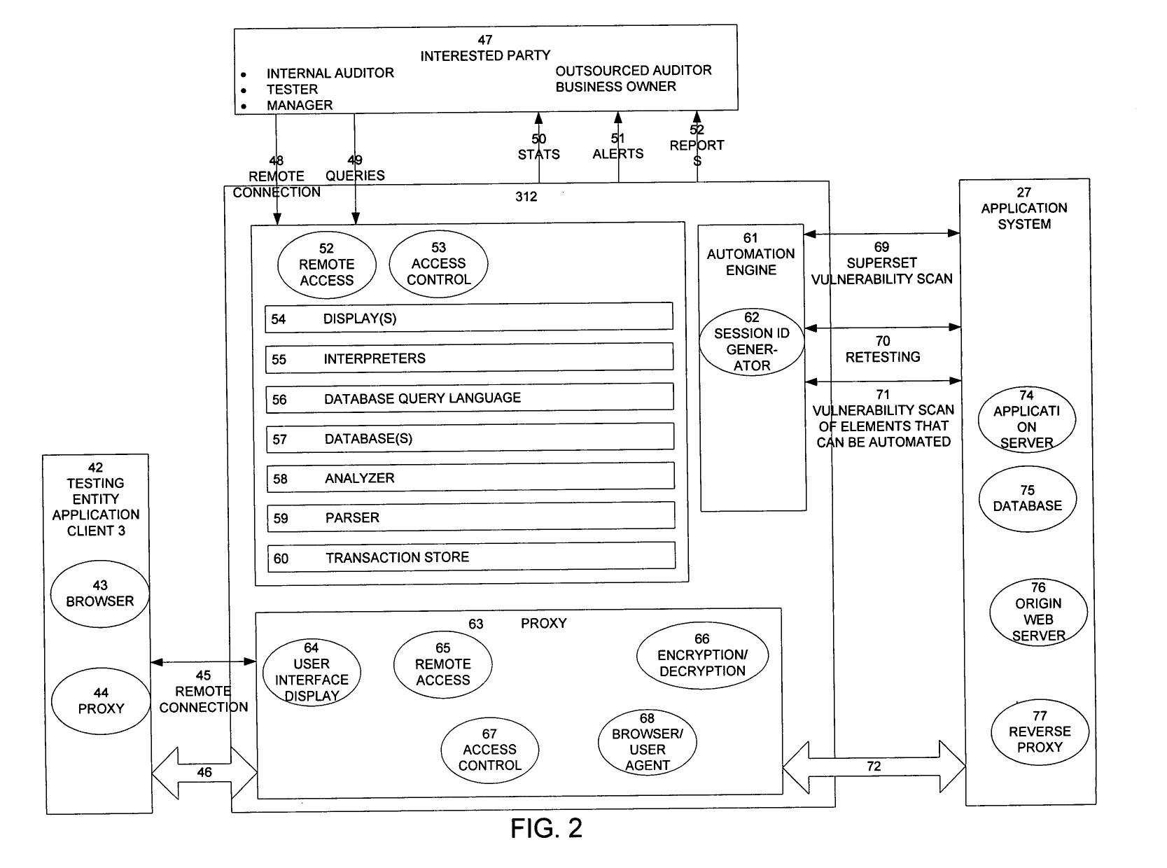

FIG. 2 shows a logical diagram of the functional components for a particular embodiment of the invention. FIG. 2 illustrates the general relationship between the functional components and their general interaction, and also illustrates the physical relationship between the components.

During security testing, data communicated between the testing entity's 42 application client 3 and the application system 27 in FIG. 2 is represented and manifest in two separate communication links: 46 and 72. Communication link 46 represents the link between the application client 3 (e.g., a browser, another proxy, or scanner) and the intermediary proxy 63. Communication link 72 represents the communication between the intermediary proxy 63 and the application system 27. Where SSL is being used, the intermediary proxy 63 acts as two SSL endpoints.

The intermediary proxy 63 is comprised of conventional functionality found in HTTP proxies as well as functionality found in proxies built for hacking web applications, e.g., ability to trap and modify request and response data, a user interface 64, remote access 65, access control 67, functionality contained within standard HTTP clients (e.g., interpreters, etc.), and encryption/decryption capability 66. The intermediary proxy 63, although shown together with various other functional elements of the invention, may or may not be collocated with other functional elements of the invention.

The intermediary proxy is installed in any network point that is accessible to the testing entity, the application system, and in most cases authorized interested parties, examples include: anywhere in a customer's environment with appropriate connectivity access to the web application system, the testing entity, and authorized interested parties within the testing entity environment with appropriate connectivity access to the web application system; the testing entity, and authorized interested parties; third party service providers with appropriate connectivity access to the web application system, the testing entity, and authorized interested parties. The intermediary proxy has access to all data flowing between the testing entity and the application system and either procedural or technical mechanisms can be used to force all data through the intermediary proxy. The intermediary proxy may act as an link endpoint and include web application proxy hacking functionality that can be leveraged to perform web application testing tasks, including: trapping all requests before being relayed to the application system; trapping all responses before being relayed to the testing entity; allowing automated parameter manipulation and manual parameter manipulation by authorized interested parties.

Additionally, for the intermediary proxy implementation, either the testing entity may be configured to proxy all requests through the intermediary proxy, or the target given to the testing entity is the address of the intermediary proxy. In the case where the testing entity is configured to proxy all requests through the intermediary proxy, the HTTP protocol specification includes an algorithm for sending messages through an intermediary, and the web application clients and servers inherently support this capability. Furthermore, the HTTP specification also provides for ‘chaining’ proxies, so where a testing entity is using a proxy, the testing entity will be required to use a proxy that supports chaining and to configure the testing entity proxy to proxy through the intermediary proxy.

In the case that the testing entity is provided with the IP address of the intermediary proxy as the target, and the testing entity is not configured to proxy, this may be done with or without providing the testing entity with the knowledge of the real origin target. The Intermediary Proxy may then be configured (hardwired) to relay the requests coming from the particular testing entity to the origin application and the responses from the origin server back to the testing entity.

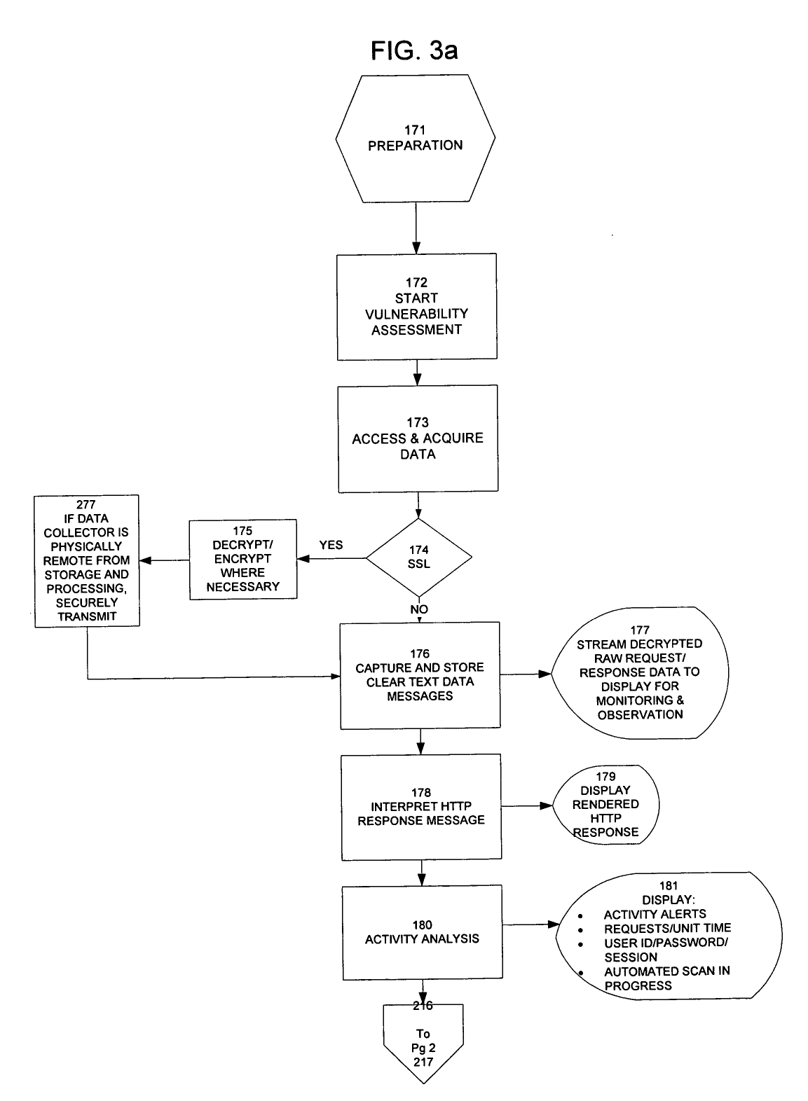

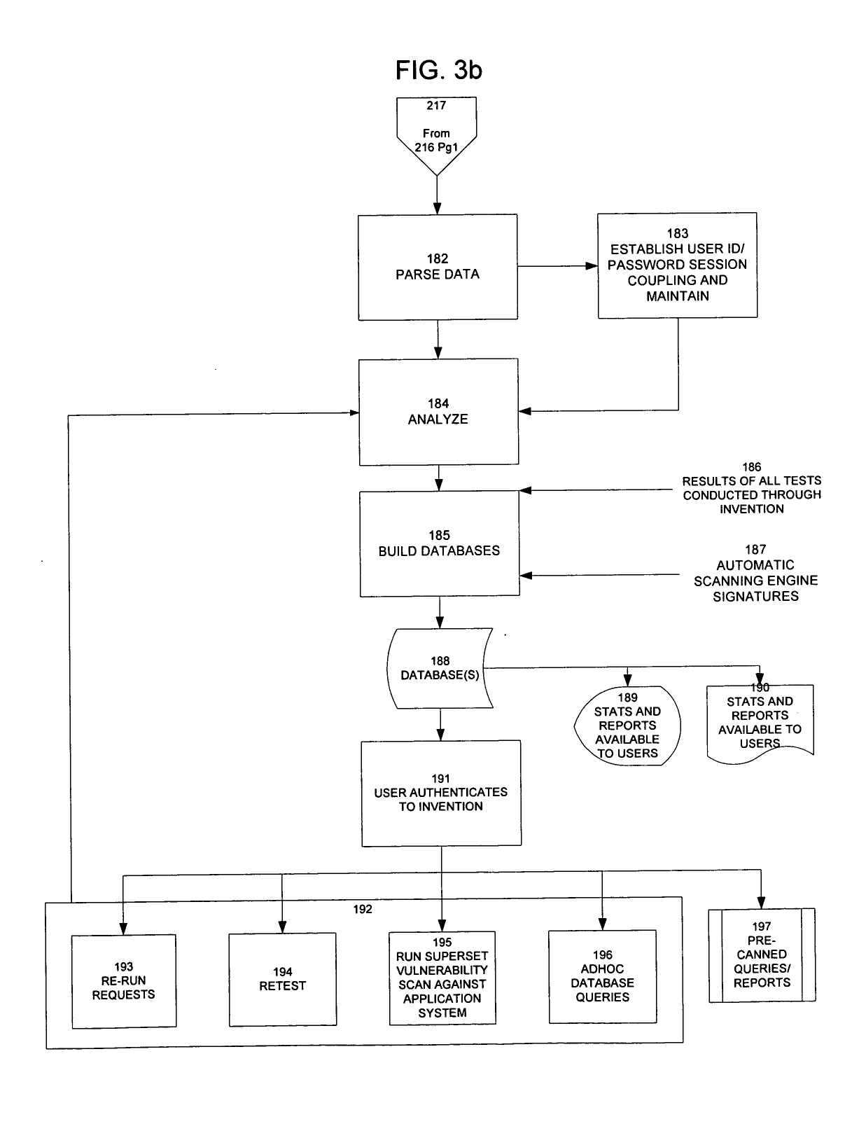

FIG. 3 shows a high-level flowchart of the operation of the invention. The flowchart begins with preparation step 171, where mode of operation decisions and configuration settings are made, as well necessary input is provided (e.g., certs, users, target, tester IP address and port, etc.)

Step 172 shows the start of the application assessment wherein the tester begins to test the system.

As data is communicated between the application client and the application system the data is accessed and acquired 173.

If SSL or encoding is being used (step 174), the data is decrypted/decoded in step 175.

If the data collector is not physically collocated with the rest of the invention, the data is stored locally and/or securely transmitted to the processing elements of the invention in step 277.

In step 176, the accessed, acquired, and clear-text data is then permanently stored.

The acquired data is then available for view and displayed if the particular functional display is in focus 177.

The raw acquired data is then processed by the interpreter 19 in step 178 and also available for view and displayed if this particular display function is in focus.

In step 180, the clear-text data is then processed by the analyzer 20 and various information is determined regarding work load and this data is available for view and is displayed if the this particular functional display is in focus in step 181.

The clear text data is then parsed in step 182. Together with the parsed data, the data set up as part of the preparation phase in step 171, the session creation and determined and its state is maintained in step 183.

The parsed clear-text data, knowledge of the session, and other information, together with various logic and rules are then analyzed in step 184 and used to build various databases in step 185, based upon results of all tests conducted 186, and automatic scanning engine signatures 187.

The databases are then available to generate stats and reports for viewing on the display 189 or as reports 190 available to users.

The acquired data and generated information can then be leveraged 192 for re-running tests 193, automating or simplifying retests 194, running superset vulnerability scans 195, running adhoc quiries against the acquired data 196, and for issuing pre-canned queries/reports 197.

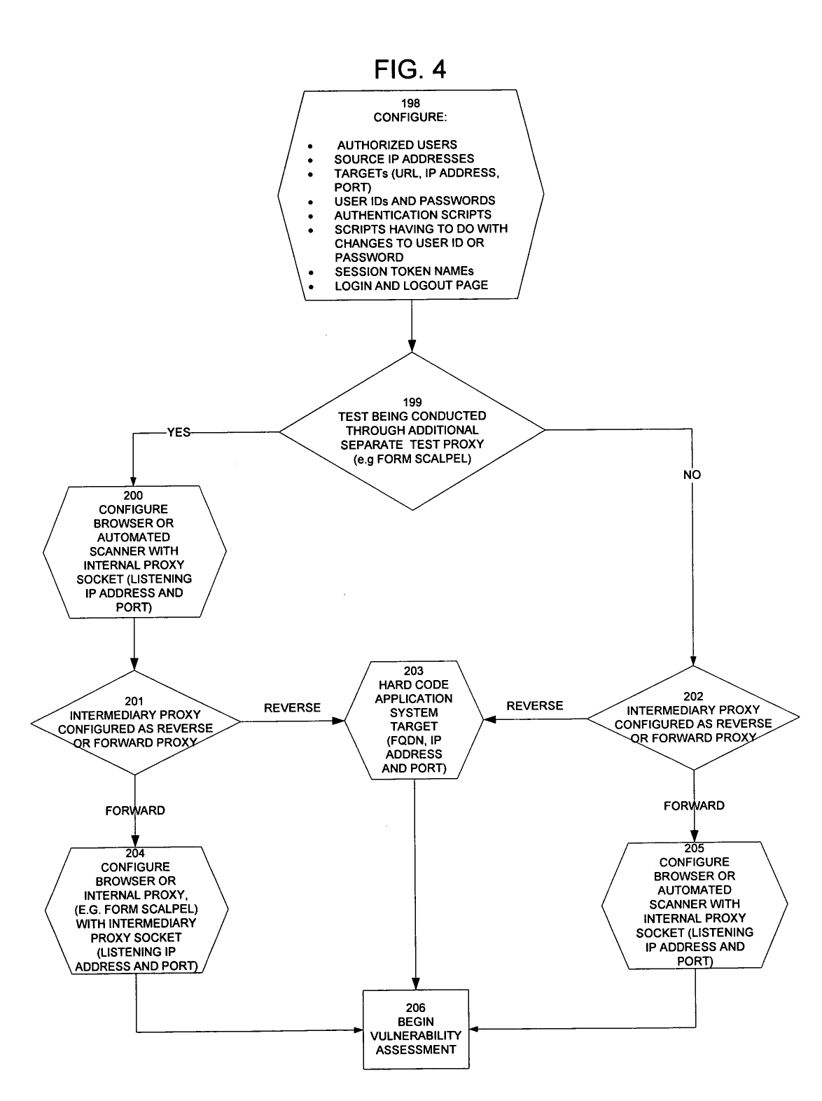

FIG. 4 shows a detailed diagram of the preparation step 171 from FIG. 2 for the first embodiment of the invention. Configuration 198 in FIG. 4, includes: authorized users; source IP addresses; targets (URL, IP address, port); user IDs and passwords; authentication scripts; scripts having to do with changes to user ID or password; session token names; login and logout page; inputting the authorized users and their authentication information (e.g., password, cert, etc.); source IP address; target application system user IDs and passwords; and scripts having to with setting or editing the user id or password.

FIG. 4 also includes a decision option 199 and two sets of configuration options depending on whether the tester is using the intermediary proxy 7 from FIG. 1, as the test proxy or rather an additional proxy (e.g., form scalpel). If an additional proxy is being used 200, then the application client (browser) is configured to proxy through this additional proxy.

In both branches of the former decision, an additional decision regarding the mode of operation for the intermediary proxy 7 in FIG. 1 is made and this represented by 200 and 201. The intermediary proxy mode of operation can either be as a reverse proxy or forward (or caching) proxy.

In the reverse proxy mode, the intermediary proxy appears as the origin server and the tester uses the intermediary proxy as the origin server (i.e., all requests will have a URL that resolves to the intermediary proxy 7 of FIG. 1). Configuration options for this mode of operation are represented in 203 of FIG. 4, which outlines the configuration necessary for the tester and the intermediary proxy 7 of FIG. 1.

In the forward proxy mode of operation, the tester configures the application client (browser or internal proxy) to proxy through the intermediary proxy 7 of FIG. 1. These configuration settings are outlined in 204 and 205 of FIG. 4.

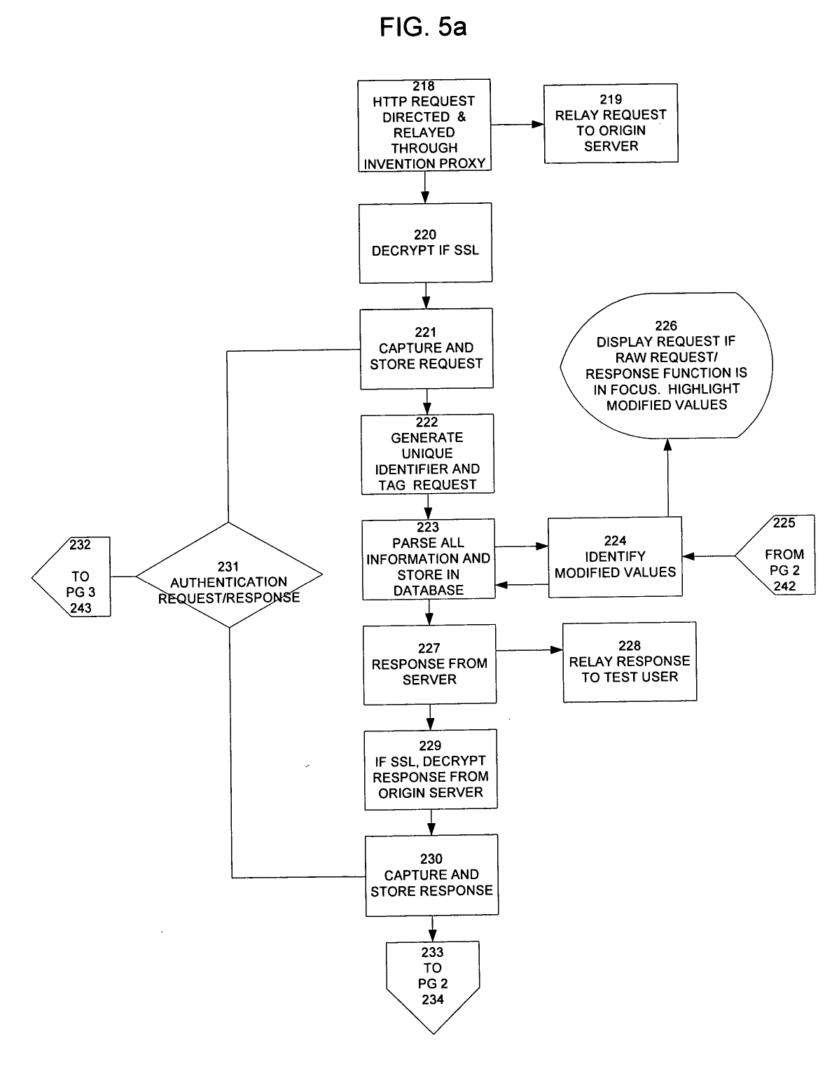

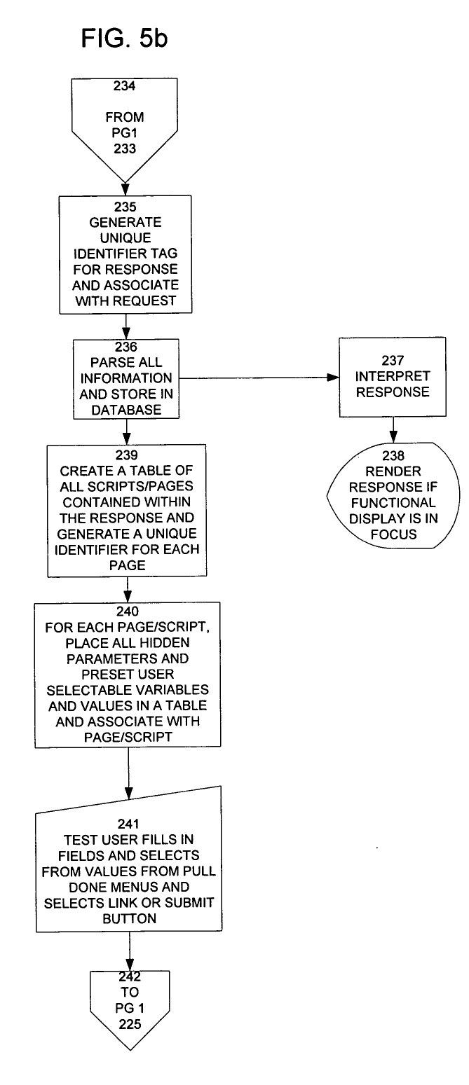

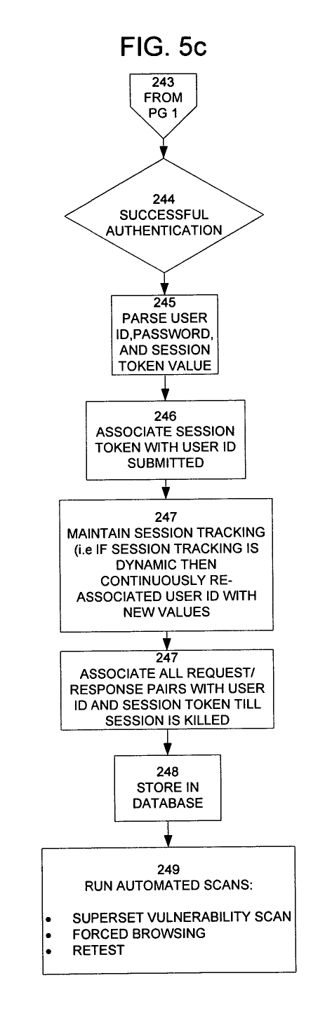

FIGS. 5a-5c illustrate a detailed flow chart for the first embodiment of the invention. In step 218, An HTTP request is directed and relayed through the intermediary proxy 7. The request can also be relayed to the origin server.

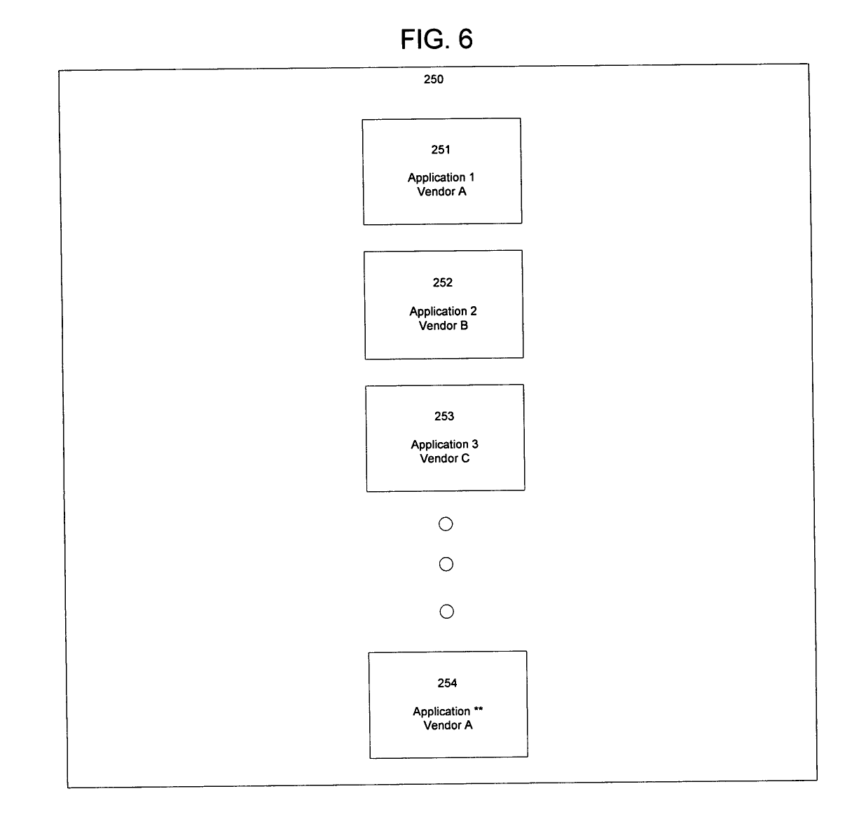

FIG. 6 shows an example top level display 250 for one embodiment of the graphical display 6 of FIG. 1, for one embodiment, providing the auditor with a visual indication of the tests 251, 252, 253, 254 being conducted, color coding may be used to indicate various meanings (e.g., red (problem), yellow (warning—may need attention), green (no known problems) status. The auditor could then select one of the tests being audited and drill down to observe more in depth information, generate statistics or metrics, etc.

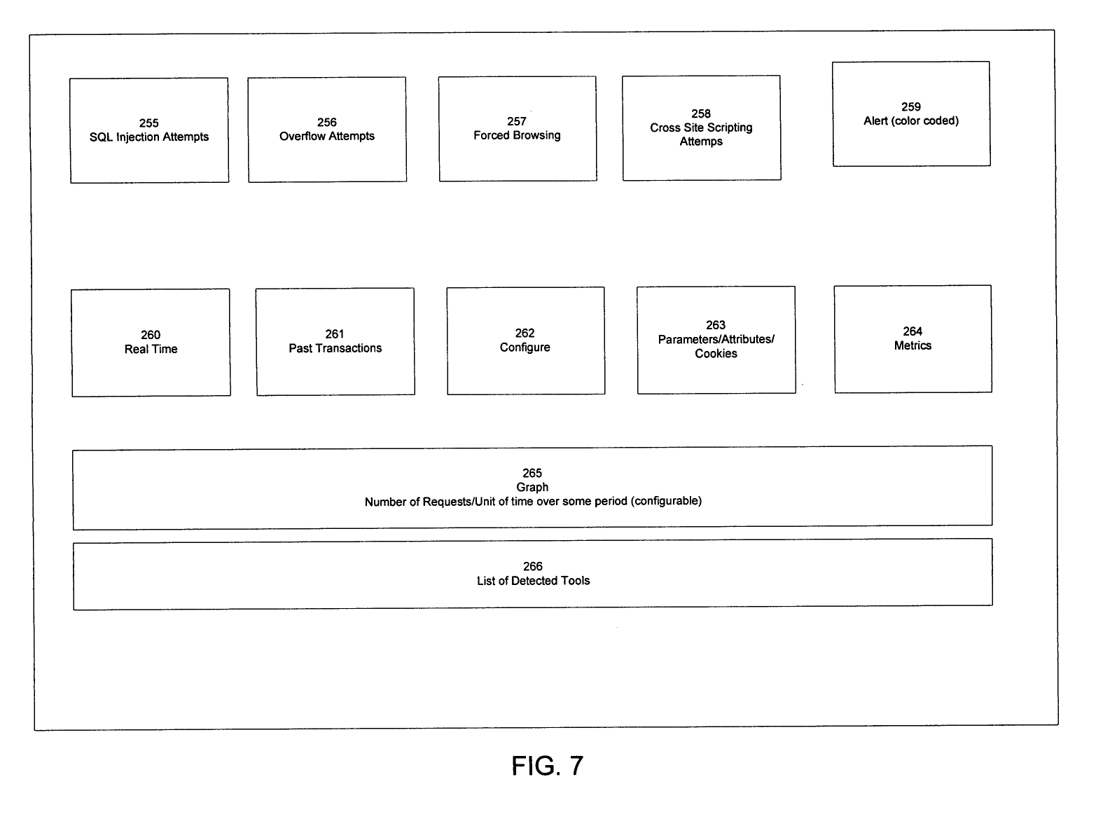

FIG. 7 shows a sample lower level display for one embodiment of the graphical display 6 in FIG. 1 that allows the user to select among a number of different test categories: SQL injection attempts 255, overflow attempts 256, forced browsing 257, and cross-site scripting attempts 258. FIG. 7 also depicts an alerts 259 tab as an example graphical component of an embodiment. The auditor(s) 39 could drill down and obtain all counts for all alerts and their corresponding threshold setting. FIG. 7 also shows various other tabs, each of which can be selected or drilled down into, including: real time 260, allowing the user to move to a display area that shows real time activity and related tabs; past transactions 261, allowing the user to move to a display area with various information and selectable options for viewing information related to past data and transactions; a configure 262 tab to select a display area that allows the user to select various configurable options; parameters/attributes/cookies 263 tab that has built-in or creatable queries that display data in various ways; metrics 264 which display all the metrics associated with the effort being viewed; a default graph 265 and tab that displays a user selectable default graph and drill down into other selectable graphs; and a list of detected tools 266.

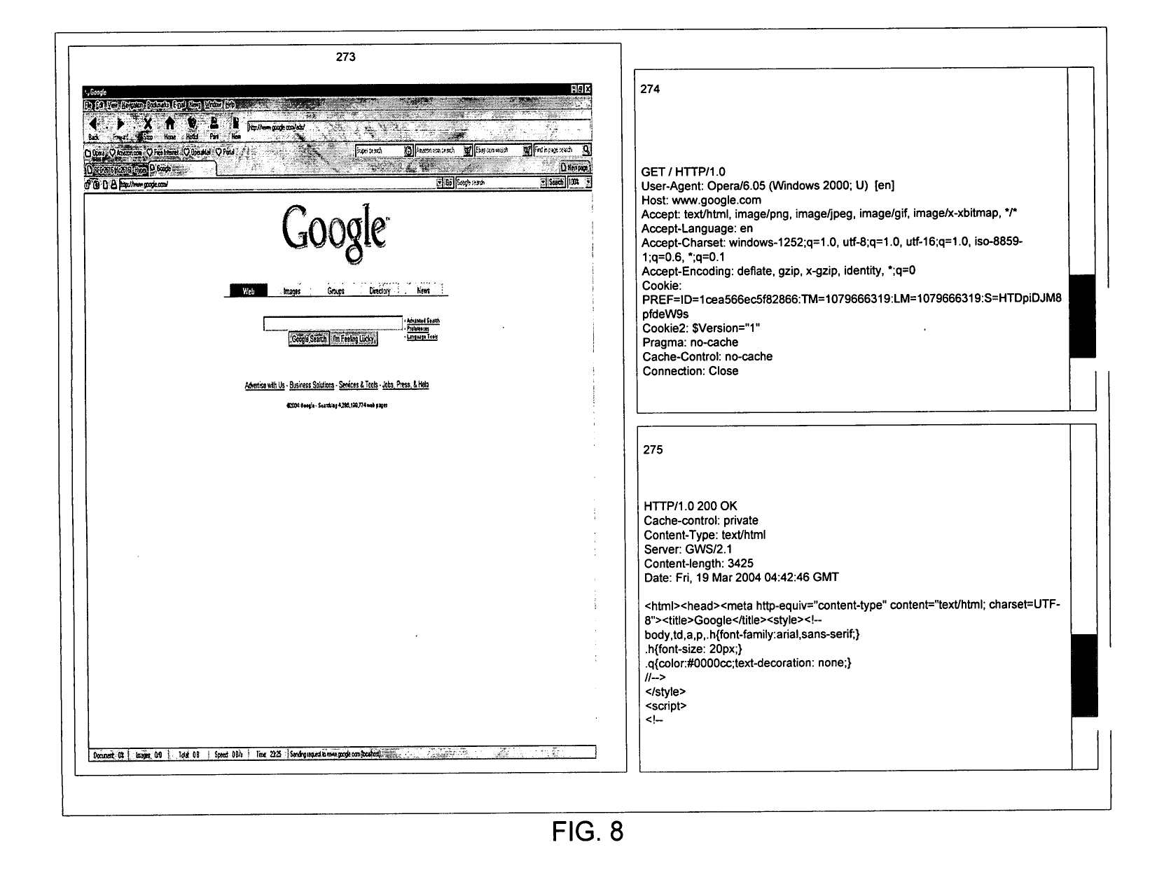

FIG. 8 shows an example display of either a current HTTP transaction or HTTP transaction selected from the database 12 of FIG. 1, as well as a sample rendered page 273. Both the HTTP Request 274 and HTTP Response 275 are illustrated.

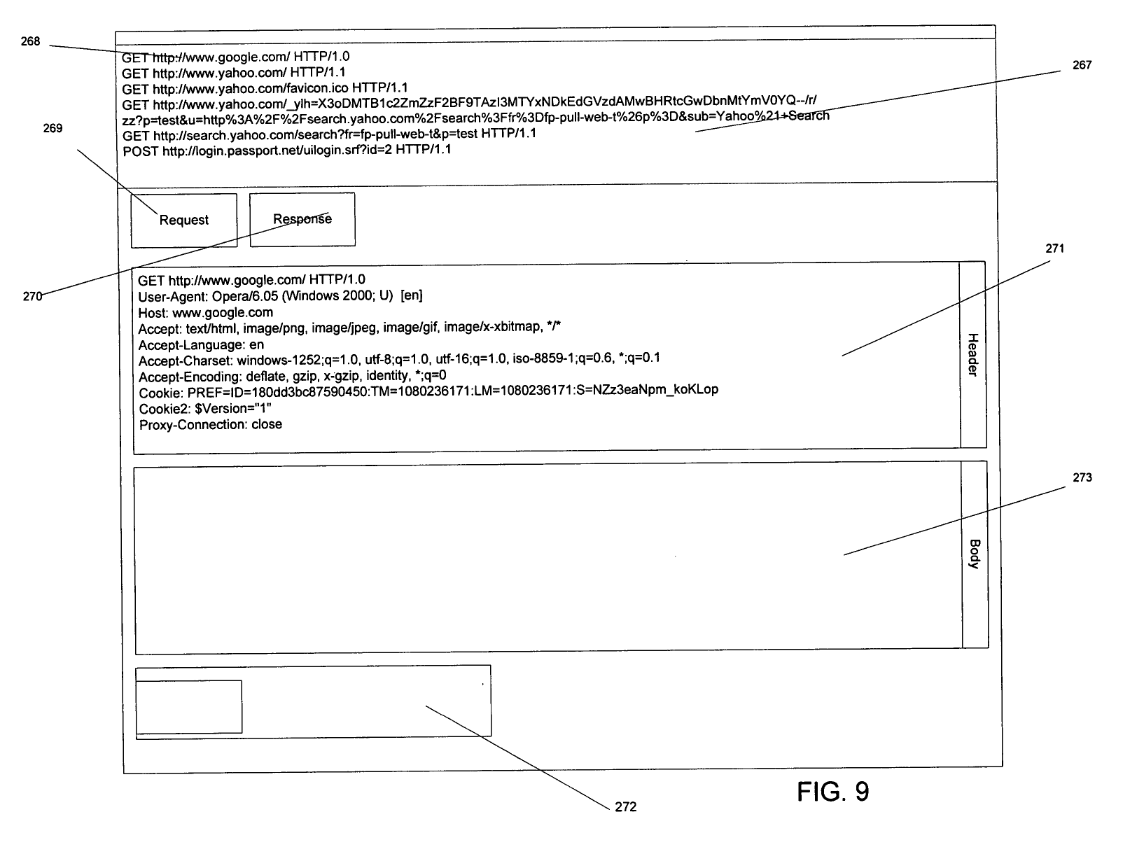

FIG. 9 illustrates an example display for an embodiment of the invention with a list of HTTPS requests 267 in the top pane. These HTTPS transactions may be any grouping of transactions, including real-time requests (i.e., the stream of requests being made at the present time), requests made for a particular session, requests associated with a particular user ID, requests containing a particular variable or variable value, requests containing a particular cookie and value, etc. Within the list of HTTPS Requests 267, one particular request 268 is illustrated. The pane directly below the HTTPS request pane 271, is the header window. This header window 271 pane is used to display an HTTPS Request or HTTPS Response Header. The user can toggle between the HTTPS Request and the corresponding HTTPS Response by selecting the request tab 269 or the response tab 270 respectively. As depicted, for the selected request 268, and selected request tab 269, the corresponding raw request header data is displayed within the header window display 267. In the pane below the header window 267, is the body window 271, where the body of either the HTTPS Request or corresponding HTTPS Response is displayed. For the particular request 268 selected in the List of HTTPS Requests, the request did not have any POST data and therefore there is no data within the body. If the Response Tab were selected by the user, the Response Header for the Response corresponding to the selected particular Request 268 would be shown in the Header Window 267 and the Body Window 273 would contain data for that response.

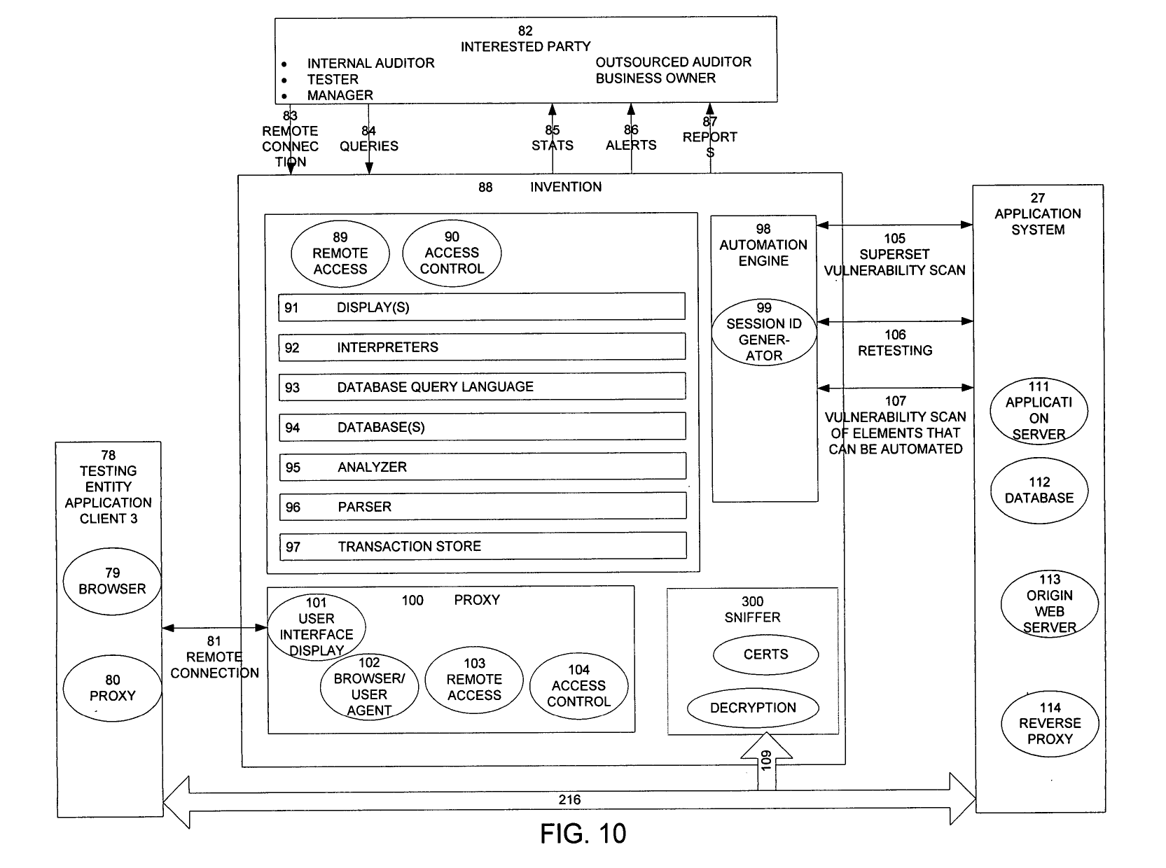

FIG. 10 shows a logical diagram of the functional components for another embodiment of the invention. FIG. 10 illustrates the general relationship between the functional components and their general interaction and is also illustrates the physical relationship between the components. Data communicated between the testing entity 78 for application client 3 and the application system 110 in FIG. 10 is represented by the communication link 108. The sniffer 300 is installed such that sniffer 300 has access to the data 108 flowing on communication link 216 between the application client 3 and the application system 110 via connection 109, and has the necessary certs and keys to decrypt this data 108 where necessary. Sniffer 300, although shown together with various other functional elements of the invention, may or may not be collocated with other functional elements of the invention.

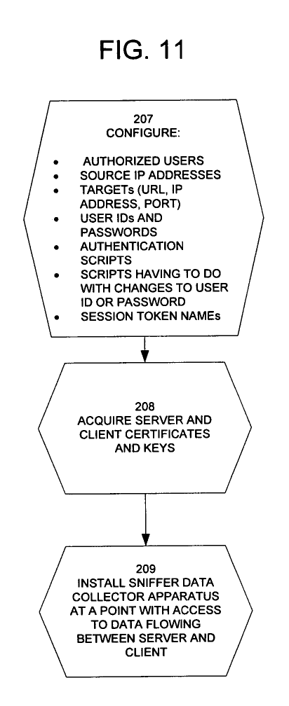

FIG. 11 shows a detailed diagram of the preparation step 171 from FIG. 3a for the embodiment of FIG. 10 of the invention. Configuration 207 in FIG. 11 includes: authorized users; source IP addresses; targets (URL, IP address, port); user IDs and passwords; authentication scripts; scripts having to do with changes to user id or password; session token names; login and logout page; inputting the authorized users and their authentication information (e.g. password, cert, etc.); source ip address; target application system user ids and passwords; and scripts having to with setting or editing the user id or password.

Step 208 of FIG. 11 shows the acquisition of application system and application client user certificates and associated keys necessary to decrypt the sniffed traffic. The sniffer 300 of FIG. 10 must be installed at a point logically between the application system and application client, with access to all data being communicated between the application client 3 and application system 27, as per step 209 of FIG. 11.

Thus, when a passive sniffer/extractor 300 is logically placed somewhere between the testing entity and the application system, the passive sniffer/extractor 300 has access to all data flowing between the testing entity and the application system. Examples include: connecting the sniffer/extractor to a hub being used by the testing entity; a software shim installed on a reverse proxy or web server; a software module installed on a standard proxy; a sniffer/extractor appliance connected to a hub that the standard proxy is connected to; and any tap into any of the communication links between the testing entity and the application system.

Web applications systems targeted for testing usually utilize SSL, which provides authentication, confidentiality, and data integrity capabilities. The intermediary proxy and sniffer/extractor may implement necessary functionality to unencode/encode, decipher/encipher, unencrypt/encrypt the communication flowing between the testing entity and the application system. Under one configuration, if SSL is being utilized, the intermediary proxy will act as an SSL endpoint. In another configuration, two SSL connections may be created: one between the testing entity and the intermediary proxy; and one between the intermediary proxy and the application system. Since proxying is one of the base techniques used by testing entities to attack/test web applications, it is may sometimes be necessary for an additional connection to be created: one between the testing entity browser/client and the testing entity proxy. As a result, the testing-entity-to-intermediary proxy connection will be from the testing entity's proxy to the intermediary proxy.

For the intermediary proxy implementation, when SSL is being used, the intermediary proxy will act as an SSL endpoint comprising a server certificate, and if necessary appropriate client certificates. Thus, the testing entity will connect to the intermediary proxy and will see the intermediary proxy as the origin server and be served an SSL certificate from the intermediary proxy rather than the application system. Accordingly, the intermediary proxy will include the necessary functionality to execute the vulnerability/penetration tests related to SSL certificates against the origin server. Also, when SSL is being used with an intermediary passive sniffer/extractor, keys and necessary logic to decipher the data being communicated between the testing entity and the application system to be supplied with the server, and if necessary the client.

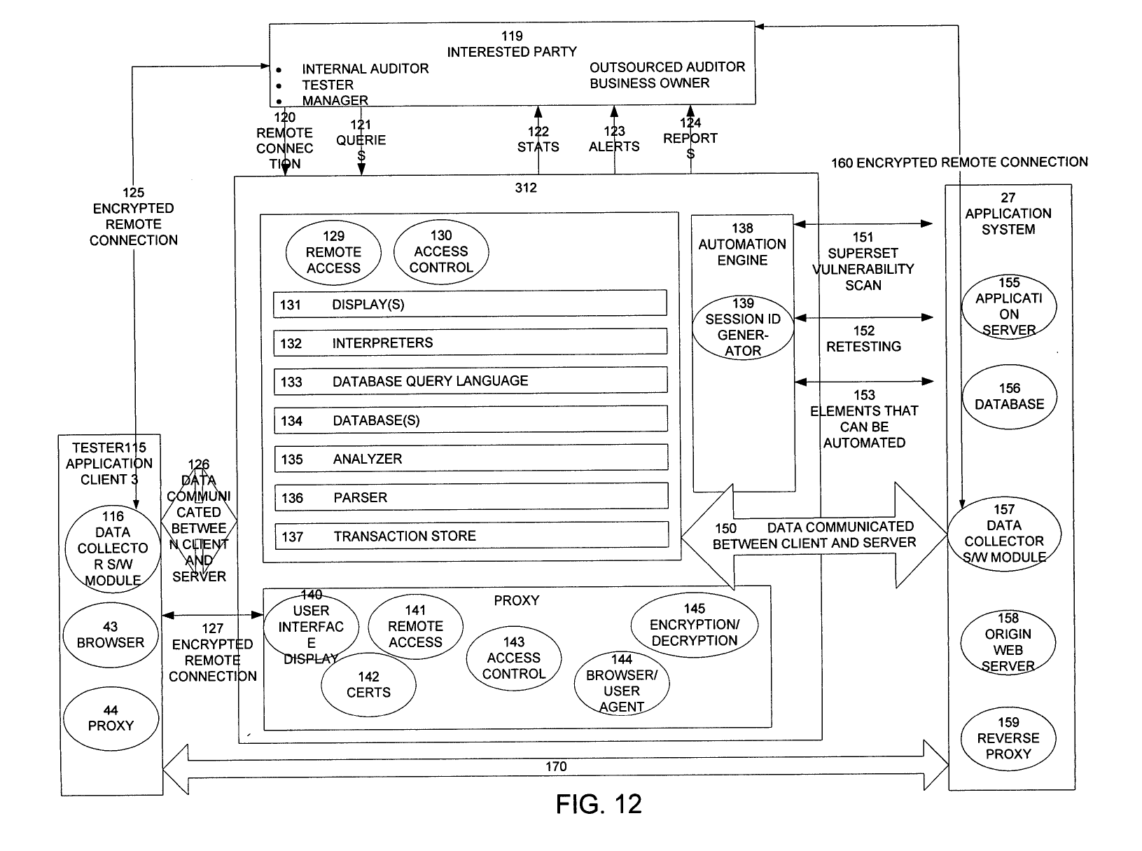

FIG. 12 shows a logical diagram of the functional components for another embodiment of the invention. FIG. 12 illustrates the general relationship between the functional components and their general interaction and also illustrates the physical relationship between the components. Data is communicated between the application client 115 and the application system 154 in FIG. 12 by a communication means represented by the communication link 170.

A data collector software module 116 is installed in the testers platform (browser of proxy) and/or a data collection software module 157 is installed in the application system (reverse proxy 159, web server 158). The data collectors 116, 157 collect the data being communicated between the application client 3 and application system 27 as well as actions being undertaken by the tester. The data collector has capabilities to store the data locally and/or securely transmit the data to the process functional elements of the invention. The data collectors 116, 157 also have remote connectivity functionality and displays to allow auditors to shadow the test.

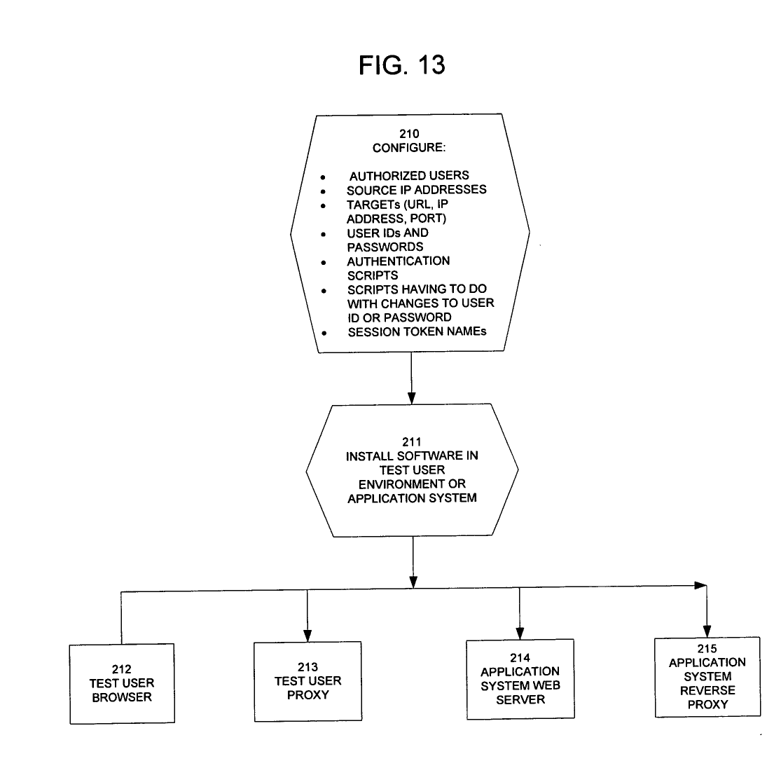

FIG. 13 shows a detailed diagram of the preparation step 171 from FIG. 3a for the embodiment of the invention FIG. 12. Configuration 210 in FIG. 13 includes: authorized users; source ip addresses; targets (url, IP address, port); user ids and passwords; authentication scripts; scripts having to do with changes to user id or password; session token names; login and logout page; inputting the authorized users and their authentication information (e.g. password, cert, etc.); source ip address; target application system user ids and passwords; and scripts having to with setting or editing the user id or password,

Installation of the data collectors and the available options is outlined in 211 through 215 of FIG. 13, whereby the software is installed in the tester's environment, or in the application system environment. This can include monitoring of the tester's browser, 212, and the testers proxy 213. Alternatively, for installation of a data collector in the application system the data collection module is associated with the application system web server 214 and the application system reverse proxy 215.

Data collecting modules or agents installed on the test entity or application system refers to computing modules that can be plugged into the testing entity and/or application system and which can record all data associated with the testing effort including data flowing between the testing entity and the application system and actions being taken by the testing entity. The use of data collecting modules installed on the testing entity and/or application system will simplify the capture of testing actions allowing for the capture of both un-altered as well altered Requests and the associated Responses.

Access to the clear-text vulnerability/penetration test data will be leveraged to capture and permanently store all data flowing between the testing entity and the application, as well as actions being taken by the testing entity, including for example: Connection data; Connection Handshaking data; SSL Handshaking Data (e.g. allowed ciphers); Sockets; Protocol Parameters, for example, HTTP Version(s); HTTP URL(s); HTTP Messages; Start Line(s); Message Header(s); Message Body(s); Request(s); Request-Line(s); Request-URI(s); General-Header Field(s) and Value(s); Request-header Field(s) and value(s); Entity-header Field(s) and Value(s); Request Message body(s); Response(s); Status-Line(s) (including Status Code and Reason); General-Header Field(s) and Value(s); Response-header Field(s) and value(s); Entity-header Field(s) and Value(s); and Response Message body(s).

For intermediary data access engine implementations (i.e. intermediary proxy and/or intermediary sniffer), storage may be local and/or securely and reliably transmitted to a central storage/processing engine. Data access engine agents installed on the test entity and/or the application system will have the capability to securely and reliably store all data locally and/or securely and reliably relay all data back to a central storage and processing engine for secure and reliable storage.

In the analyzer, logic applied to the data accessed, collected, parsed and stored, towards yielding information about the data itself, the application system, the testing effort, state-of-the-art, vendor capabilities, trends, and statistics, will include for example:
determining actions being taken by the testing entity (e.g. parameter value manipulation);
determining whether and when scanners are being used;
determining the rate of testing (requests per unit of time);
creation of a mapping between the User ID and the session credential set upon successful authentication;
coupling of the User IDs to all requests generated while the testing entity is authenticated as the particular User ID;
identification of hidden form fields and the initial value set within the response;
determination of hidden form fields value changes, affected through manipulation by the testing entity, and the resultant effect or Response;
determination of the particular request(s) that result in the session id being created;

When a set of determined User ID/password pairs, as well as the determined script/page where the User ID and password are submitted for authentication, the data will be leveraged by the automation engine to generate valid session ids on the fly, as necessary (e.g. replay or other test against a particular script/page for which a particular user id has authorization for use in testing, retesting, and replay efforts (e.g. CSS, sql injection, parameter manipulation).

Access to and/or storage of the clear-text data will allow the data to be parsed, and used in the building of database(s) of information for the testing effort, including the following examples:
Action Being Taken By Testing Entity/Hacking techniques used by the testing entity;
Testing activity;
Testing inactivity;
Type of testing activity (manual or scanning) and times;
Time period between HTTP Requests;
Average time between HTTP Requets;
Number of Requests for a given period;
Inactivity intervals (periods of time when no testing is taking place;
Activity associated with known scanners;
Periods where scanners are being run;
Time when scanners started and ended;
Number of times scanners run;
Pages/Scripts/JSPs/etc. request in a given period;
Test Accounts used in testing in a give period;
URLs Requested in a given period;
List of URLs/pages/scripts requested in a given period of time;
List of accounts used in testing;
Aggregate list of all parameters (e.g. cookies, POST, GET, Headers) submitted and all values submitted, including both expected and manipulated;
Number of different parameters;
Number of forms, by account and for all accounts;
Number of Fields, by account and for all accounts;
Aggregate list of pages/scripts (e.g. servlets, html, htm, asp, cgi) requested and resultant response, without being authenticated, by account and for all accounts;
Number of pages, by account and for all accounts;
List of HTTP Methods (GET, POST, PUT, DELETE, TRACE/TRACK, OPTIONS), associated pages/scripts, directories, by account and for all accounts;
List of parameters where parameter manipulation techniques were applied, values before and after, and the resultant responses, by account and for all accounts;
List of Pages/scripts where parameter manipulation techniques were applied, the parameters, values (before and after), and the resultant responses, by account and for all accounts;
Number of different SQL strings, by account and for all accounts;
Number of pages where SQL strings submitted were submitted;
Aggregate of all SQL Injection strings used in the testing effort, by account and for all accounts;
List of Pages/scripts where SQL Injection techniques were applied, the parameters, strings, and resultant responses, by account and for all accounts;
List of parameters where SQL Injection techniques were applied, the associated page/script, string, and the resultant response, by account and for all accounts;
Aggregate of all Cross-site Scripting strings used in the testing effort, by account and for all accounts;
Number of different Cross-site Scripting strings, by account and for all accounts;
Number of pages where Cross-site Scripting strings submitted were submitted;
List of Pages/scripts where Cross-site Scripting techniques were applied, the parameters, strings, and resultant responses, by account and for all accounts;
List of parameters where Cross-site Scripting techniques were applied, the associated page/script, string, and the resultant response, by account and for all accounts;
Aggregate of all Buffer-overflow strings used in the testing effort, by account and for all accounts;
Number of pages where Buffer-overflow strings were submitted;
List of Pages/scripts where Buffer-overflow techniques were applied, the parameters, strings, and resultant responses, by account and for all accounts;
List of parameters where Buffer-overflow techniques were applied, the associated page/script, string, and the resultant response, by account and for all accounts;
Aggregate of all HTTP Response Splitting (CR/LF Injection) strings used in the testing effort, by account and for all accounts;
Number of different HTTP Response Splitting strings;
Number of requests where HTTP Response Splitting strings were submitted;
List of Pages/scripts where HTTP Response Splitting (CR/LF Injection) techniques were applied, the parameters, strings, and resultant responses, by account and for all accounts;
List of parameters where HTTP Response Splitting (CR/LF Injection) techniques were applied, the associated page/script, string, and the resultant response, by account and for all accounts;
Information harvesting techniques;
Forced Browsing techniques, pages/scripts, for each account;
Aggregate list of authentication attempts, User IDs, passwords, and resultant responses;
Aggregate list of Messages (and the associated complete HTTP Response), resulting from failed authentication attempts, by account and for all accounts;
Aggregate list of pages/scripts where User IDs were submitted, User ID values, and the resultant response, by account and for all accounts;
Scanners used;
   Pages requiring entitlements (e.g. administrative pages/scripts);
Forced browsing—pages/scripts requiring entitlements request for each account (e.g. administrative scripts);
Authentication;
Basic Authentication;
User ID/Password;
Client-Side Certs;
Authentication Credentials (User IDs, Passwords, Client-side Certs,
Base64 encoded username/password);
Passwords;
List of pages/scripts having to do with password operations;
List of pages/scripts where passwords were passed within the request;
Aggregate of all passwords accepted for authentication;
Aggregate of all passwords not accepted for authentication and resultant response;
Aggregate of all passwords accepted for setting a password (e.g. account creation, password change, etc.);
Aggregate of all passwords not accepted for setting a password and resultant response;
Response Messages for failed password operations (e.g. invalid User ID/any password, valid User ID/invalid password, valid User ID for locked account/invalid password, valid User ID for locked account/valid password);
Aggregate of all values submitted for parameters of type password or submitted to a script having to do with passwords;
All passwords for each account;
Whether the password is ever transmitted in clear text using HTTP;
Accounts (e.g. User IDs, Certs, roles, etc.);;
All Accounts used in testing
All passwords used for each account;
Aggregate of all passwords submitted for each account;
URLs requested for each account;
All session ids for each account;
All pages/scripts requested for each account;
Aggregate list of all requests and associated responses for each account;
All pages/scripts/requests that pass the User ID as a parameter and the associated parameter name;
Parameter values submitted for each test account;
Aggregate list of all parameters and values for each account;
Aggregate list of all cookie Names and Values for each account;
Aggregate list of all SQL strings submitted for each account, pages/scripts and parameters for each;
Aggregate list of all CSS strings submitted for each account, pages/scripts and parameters for each;
Aggregate list of all CR/LF strings submitted for each account, pages/scripts and parameters for each;
Aggregate list of all Session Tokens associated with each account;
Number of URLs requested for each account;
Number of parameters submitted for each account;
Number of accounts;
Session data (e.g. session tokens);
Request that results in the session token being generated;
Aggregate list of all session tokens and accounts associated with each;
Aggregate of URLs for all Session tokens (e.g. whether the session token was ever passed unencrypted using HTTP);
Pages/Scripts requested for each session token;
All accounts or User IDs bound to a session token (Re-use of session tokens);
Whether the session token is ever transmitted using HTTP;
Session Creation
Aggregate list of all authentication credentials;
Whether Authentication Credentials ever passed unencrypted and the specific request/page and/or response;
Whether Identification information is transmitted subsequent to authentication;
Whether session credential is ever passed unencrypted and the specific request/page and/or response;
Aggregate list of all Set Cookie strings;
Sequence order of authentication and creation and setting of the session credential;
Aggregate list of pages/scripts, associated responses, and the operations performed on all session credentials (over-writing, destroying, setting to null)
Aggregate list of all persistent cookies containing any of the User ID, password, or session credential;
Logout data—list of pages/scripts resulting in the session credential value being changed;
Cookies;
Aggregate list of all cookies, for a session, for all sessions, and by account and for all accounts;
Security Settings for each cookie, by account and for all accounts;
Cookie Path for each cookie, by account and for all accounts;
Cookie Domain for each cookie, by account and for all accounts;
Cookie persistence for each cookie, by account and for all accounts;
By Particular HTTP Request/Page (e.g. Process, Script, Servlet, JSP, ASP, CGI);
List of HTTP Response(s) by account and for all accounts;
List of all HTTP Response Headers and values, by account and for all accounts;
List of all HTTP Request Headers and values, by account and for all accounts;
Meta-tags;
Caching Directives;
Autocomplete Directive;
Aggregate list of all parameters submitted for each HTTP Request and all values, by account and for all accounts;
Expected value for each parameter where possible;
All values submitted for all parameters submitted for a particular HTTP Request;
HTTP Responses for a particular HTTP Request, session, and set of submitted parameters and values;
User ID associated with the submitted session credential for the particular HTTP Request;
All session tokens and associated User ID for which an HTTP Request was made for the particular Page/script;
All SQL Injection strings used and for which parameters;
CSS strings used and for which parameters and HTTP Request components;
Buffer Overflow Strings used and for which parameters;
CR/LF Injection strings and for which parameters;
Date-Time Stamp of HTTP Messages;
List of HTTP Response Status Codes for each requested page/script (e.g. Successful 2xx, Redirection 3xx, Client Error 4xx, Server Error 5xx), by account and for all accounts;
List of Response Headers and values for each requested page/script, by account and for all accounts;
List of Response Messages (e.g. Found, OK, Not Modified, Internal Server Errror) for each requested page/script, by account and for all accounts;
List of Embedded Comments for each requested page/script, by account and for each account;
Aggregate of Cache Request and Response directives;
Aggregate of all accounts/User IDs used to request page (e.g. forced browsing);
Caching Directives;
Paths/Directories;
All parameters and values;
Parameters submitted for each page;
Meta-Tags;
Auto-Complete Directives;
Error messages;
List of all Form Names;
All HTTP Protocol Versions (HTTP 1.0, HTTP 1.1)
Raw unaltered Requests;
Raw altered Requests;
Directories
List of all directories;
HTTP Methods Requested (e.g. OPTIONS, GET, HEAD, POST, PUT, DELETE, TRACE, CONNECT) for each directory;
By Parameter
List of all Values, by account and for all accounts;
List of all CSS strings, by account and for all accounts;
List of all SQL strings, by account and for all accounts;
List of all CR/LF strings;
List of all URLs/pages/scripts where parameter was submitted and associated values;
All requests made be Web Application Vulnerability Scanners (e.g. Nikto, Whisker, ISS, Nessus, Stealth, etc.)
Building a Superset Web Application Vulnerability Scanner Database

A superset database of vulnerable material will be built and continuously updated with data captured from vulnerability tests being conducted through this method, including:
Vulnerable scripts/pages for all tests conducted through this method (e.g. vulnerability scanning engines—NIKTO, ISS, NESSUS, STEALTH, WHISKER, TYPHON, etc.);
CSS strings submitted during the tests run through this method;
All SQL injection strings for all tests submitted through this method;
List of application system components (web server, application server, proxy server) for each application system;
List of components susceptible to CSS, SQL injection, and CR/LF injection;
Realtime Monitoring and Viewing

Displays, interpreters, code/logic and access to the data being communicated between the test entity and the application system, as well as derived data, will allow authorized interested parties to view, in real-time as well as replay, all aspects of the testing activity, related generated information, including a display of all examples listed in previous claims, as well as the following examples:
Raw HTTP Requests and Responses;
Rendered/interpreted Responses;
Parameter manipulation;
Lack of testing activity;
Signals indicating activity or lack of activity;
Signals indicating the use of a scanning utility;
List of URLs requested;
Any of the data cited in claims 37 and 40;
Findings detected by method;
Data/Information Reporting

Access to the data being communicated between the test entity and application system, as well as derived data, will allow for the generation of reports to include for example, all data listed above. Thus, authorized interested parties can make ad-hoc and pre-canned queries against the stored data for either a test currently in progress, or a past test; and can retrieve and/or view reports containing various information indicating the completeness and efficacy of the test(s), including the following examples:
Statistics;
Comparison data;
Directories;
Scripts/pages Requested;
Accounts and passwords used;
Parameters and values;
Access Control:Authorized Interested Party

Thus, access control protects and governs access to all functionality and data, including:
which source IP addresses can make connections through an intermediary proxy data access engine and to which application systems;
which source IP addresses and accounts can make connections to agent data access engine;
which source IP addresses and accounts can access the functionality provided by the method;
which source IP addresses and accounts can access the data and reports provided by the method; and
which interested parties can make connections for monitoring, database queries, reporting, scanning, scoring, etc.

The agents will also include the necessary logic for an authorized interested party to securely connect to the data collecting modules. In combination, or separately, this will allow interested parties the same view into testing activity as the intermediary and sniffer implementations.

A testing engine platform may be included that implements all the necessary functionality to communicate with the application system, and which can be used to:
replay stored requests with or without modification by an authorized, authenticated, interested party that can be leveraged by authorized testing entities and other authorized interested parties;
to run automated scans using the superset vulnerability database described above, and
used as the proxy through which the testing entity can conduct tests.

Endless different client-server applications fall within the scope of the invention. The description has been primarily directed to an HTTPS web client-server application. However, it would be understood by one of ordinary skill in the art that the principles and claims of the invention are applicable to other client-server applications and other embodiments of the illustrated HTTPS web client-server application.

Examples of application system components to which the present invention might be applied include web servers, JAVA containers and application servers, ASP application servers, interpreters, databases, reverse proxies, load balancers, filters, middleware, application processes (any code) or script (e.g., cgi, JSP, Servlet, ASP, etc).

While specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Combinations of the above embodiments, and other embodiments not specifically described herein will be apparent to those of skill in the art upon reviewing the foregoing disclosure. The scope of the invention should properly be determined with reference to the appended claims, along with the full range of equivalents to which such claims are entitled.

1. A method for auditing a security test of a system, wherein a tester is in communication with the system via a communication link, the method comprising:
providing a data collector that accesses and gathers the data being communicated between the tester and the system being tested;
collecting and storing data passing between the tester and the system;
analyzing the collected data to determine the effectiveness of the vulnerability/penetration assessment test.

2. The method of claim 1, further including the step of displaying the data and information about the data, providing auditors with realtime information regarding the vulnerability/penetration assessment test.

3. The method of claim 2, further including the step of providing and making available to testers and auditors an assessment proxy.

4. The method of claim 3, further including the step of utilizing captured username/password pairs, and the request used to authenticate, in the generation of valid sessions on the fly for retests, and automated scanning tests.

5. The method of claim 4, further including the step of providing a scanning engine that can re-run captured requests to perform retests upon remediation of vulnerabilities.

6. The method of claim 1 further including the step of including an intermediary proxy as the data collector, said proxy collecting the data passing between the tester and the system being tested, and storing said collected data in a storage.

7. The method of claim 1 further including the step of including a sniffer as the data collector, said sniffer extracting from said communications channel the data passing between the tester and the system so that the data is collected and stored as collected data.

8. The method of claim 1 further including the step of including a software module that can be installed within the tester's environment as a data collector, said software module providing remote connectivity and extracting the data passing between the tester and the system so that the data is collected and stored as collected data.

9. The method of claim 1 further including the step of providing the collected data to a transaction database for analysis.

10. The method of claim 1 further including the step of building other databases, including a superset vulnerability database, based upon the collected data.
